(19) United States
(12) Patent Application Publication
(10) Pub. No.: US 2013/0125165 A1
(43) Pub. Date: May 16, 2013

(54) System and Method for a Customized Media Platform

(71) Applicant: Robert A. Oklejas, Monroe, MI (US)

(72) Inventor: Robert A. Oklejas, Monroe, MI (US)

(21) Appl. No.: 13/677,100

(22) Filed: Nov. 14, 2012

Related U.S. Application Data
(60) Provisional application No. 61/559,436, filed on Nov. 14, 2011.

(51) Int. Cl. H04N 21/81

(52) U.S. Cl. CPC H04N 21/8126
USPC 725/34

(57) ABSTRACT

A customized media platform that combines audio and visual content or programming with customized advertising and client-specific content is provided through a remote server coupled to a communication system that transmits audio and visual content along with signaling for insertion of customized content to a localized end user location where a server receives the audio and visual content and inserts customized content for transmission to one or more viewers.

### CROSS-REFERENCE TO RELATED APPLICATIONS

The present invention is related to, and claims priority to, U.S. Provisional Application Ser. No. 61/559,436, filed Nov. 14, 2011, which is hereby incorporated by reference.

### FIELD OF THE INVENTION

The present invention relates to a method and system for customizing audiovisual media at an end user location through media platforms having media content, network configurations and delivery systems.

### BACKGROUND OF THE INVENTION

Traditional television networks rely on various systems for delivery of programming including audiovisual media through traditional analog signals, digital cable signals, satellite signals, and computer-aided network communications. Typically, programming offered by a traditional television network company is directed to various programming interspaced with advertisements purchased by companies and intended to reach broad geographical markets. These systems have very limited ability to customize programming and advertising specific to an end user entity, such as a hospital, restaurant, or other small consumer. It is impractical and not readily available to provide specific programming and information embedded in the network programming directed to a specific end user such as a hospital entity. Currently, there is no good solution for offering a customized programming environment interspersed with directed advertising and information specific to an entity such as a hospital. Therefore, there is a need for such a system and an ability to take network programming, customized programming, local programming and entity-specific programming and mix this programming with advertising and other information specific to the entity. Further, it is desirable that a customized system for delivering directed programming together with advertising and other information be available as a low cost alternative to costly programming packages and systems currently available.

### SUMMARY OF THE INVENTION

It is therefore one object of the invention to provide a system capable of delivering customized audiovisual content to an end user location. It is a further object of the invention to customize the programming to include end user content specific to institutions such as hospitals or a restaurant chain. Another object of the invention is to provide a low cost solution for integrating custom content into live or pre-recorded programming through a server system local to the end user.

The present invention provides a system and method for customizing audiovisual content at a user location, comprising the steps: providing an audiovisual broadcasting system for broadcasting live and recorded audiovisual content wherein the audiovisual content is digitized and wherein the broadcasting system comprises a playout server for receiving, storing and transmitting audiovisual content, wherein the broadcasting system further comprises a transmitter for transmitting the audiovisual content; transmitting the audiovisual content to a digital program insertion server in networked communication with an end user location; inserting into the audiovisual content additional content wherein the additional content includes at least one of advertising and customized content wherein the customized content is specific to the end user; transmitting by the playout server a cuing signal for signaling an insertion point for insertion of customized content whereby the audiovisual content is customized and delivered to an end user.

One feature of the invention is that it allows an end user to receive an audio video feed and control the embedding and addition of advertising and end user content information. Another feature of the invention is the inclusion of a digital program insertion server that combines received media including audiovisual media with customized end user content where the digital program insertion server is controlled by the end user. An additional feature of the invention is the inclusion of cuing signals for signaling the insertion of an advertisement or other customized media content. Yet an additional feature of the invention is an ability to combine and display concurrent combined media, including audio media, video media, advertising and end user content media. Options for a combination include splitting the screen overlay and fixed display or ribbon feeds of information at an end user monitor or television.

Other objects and features of the present invention will become apparent when viewed in light of the detailed description of the preferred embodiments when taken in conjunction with the attached drawings and appended claims.

### BRIEF DESCRIPTION OF THE DRAWINGS

The present invention will become more fully understood from the detailed description and the accompanying drawings, wherein:

FIG. 1 is a block diagrammatic view according to the present invention;

FIG. 2 is a block diagrammatic view of a preferred embodiment according to the present invention;

FIG. 3 is a block diagrammatic view of a second preferred embodiment according to the present invention;

FIG. 4 is a block diagram of a third preferred embodiment of the present invention;

FIG. 5 is a block diagram of a fourth preferred embodiment of the invention;

FIG. 6 is a block diagram of a fifth preferred embodiment of the invention;

FIG. 7 is a block diagram of a sixth preferred embodiment of the invention;

FIG. 8 is a block diagram of a seventh preferred embodiment of the invention; and

FIG. 9 is a block diagram of an eighth preferred embodiment of the invention.

### DESCRIPTION OF THE PREFERRED EMBODIMENTS

In the following figures, like reference numerals are used to identify identical components in the various views and embodiments. The following example is meant to be illustrative of preferred methods for implementing the customized media platforms of the invention. However, those skilled in the art will recognize various alternative embodiments. For example, various communication protocol networking systems may be used to implement the invention.

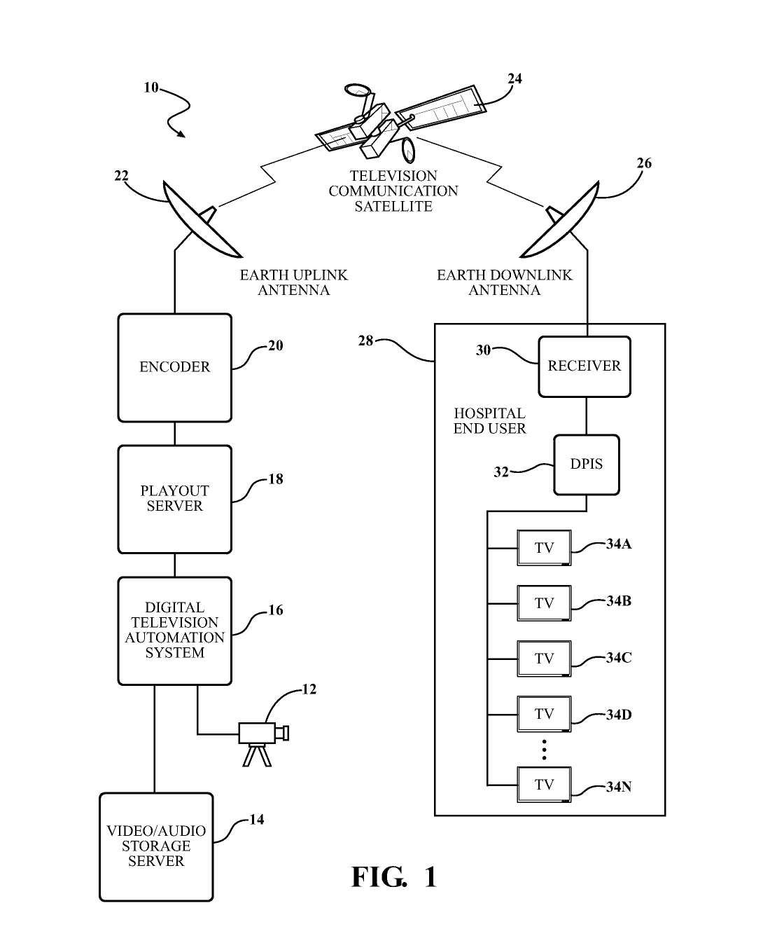

Referring now to FIG. 1, an embodiment of a customized media platform 10 is illustrated. The customized media platform has a camera 12 and a video/audio storage server 14 coupled to a digital television automation system (“DTAS”) 16. Most modern television producers and stations operate on a digital basis using DTAS to create, store and deliver program media content. The digital content may be either recorded or live. The digital program files are stored in a server computer as recorded data or routed through the servers in real time for live content. The DTAS is in communication with a playout server 18 that sends a digital output to the transmission system including an encoder 20 adapted to encode the digital content in a protocol suitable for transmission. Transmission protocols include those known to someone skilled in the art. The encoder 20 is coupled to a satellite dish 22 for transmitting a programming signal to a television communication satellite 24. The television communication satellite 24 may be a geostationary satellite. The satellite relays the programming signal to a downlink antenna 26. Downlink antenna 26 is preferably a satellite dish. At the receiving end of the programming signal originating from the digital television automated system 16 is a hospital end user 28. The hospital end user 28 includes a receiver 30 for receiving and decoding a programming signal. Receiver 30 is in communication with a digital program insertion server (“DPIS”) 32. The DPIS 32 stores and inserts digital files of customized content. The insertion of the custom content allows the hospital to create its own branded platform. As an example, two 30 second commercial avils and two identification spots can be customized with hospital promotional messages, public service announcements, or commercials. Together, a custom-branded platform that suits the business purpose of the hospital is created. This also includes an ability to provide therapeutic audio and video experiential content to a patient. The DPIS 32 is in communication with televisions 34a, 34b, 34c, 34d, . . . 34n. Televisions 34a-34n are any suitable television or monitors capable of displaying video and/or audio content.

The method for the creation and the delivery of media through the customized media platform 10 is to enable a central media platform originator to create and distribute a low-cost customized platform to end users such as hospitals, hospital systems, health care organizations, corporations, government agencies, communities, individual enterprises, small businesses, other television networks, and other entities that have in-house media distributions including local area network (“LAN”) and wide area network (“WAN”) systems. Thus, the customized media platform 10 can be a source of information and entertainment content to the end users media viewers and a source of advertising revenue and other forms of sales revenue to the organization itself.

The customized media platform incorporates a central media studio that produces digital audio and video content, preferably in the form of 24/7 broadcasting of media content and then distributes that broadcast to a remote location, either through satellite uplink/downlink or antennas/receivers. Additional modes of transmission include direct communication such as fiber optic cable, microwave and coaxial cable or by any public or private platform LAN and WAN-based systems. One embodiment of such a platform is the eScapes network which provides 24/7 content based on the hybrid television radio system/therapeutic benefit television system described in U.S. patent application Ser. No. 11/275,960, the disclosure of which is incorporated herein by reference in its entirety to the extent it does not conflict with the general scope of the present invention. Hybrid radio/television (“HTR”) content is an essential component of the customized media platform 10 as HRT content will comprise the majority of the platform's programming schedule. HRT content allows for the economical creation of thousands of hours of high functioning, high testing programming, thus making very limited distribution platforms affordable.

As an example, and including the eScapes network, television content is based on a one-hour program divided into four equal segments. Each segment is typically 15 minutes long and may contain 13 minutes and 50 seconds of programming content (an individual episode), two 30 second commercial avils, one three second and one seven second network identification spot. However, it is to be appreciated that other time intervals may be utilized without deviating from the scope of the present invention. In this example, the reception location is a hospital or hospital system. At the hospital is located the receiver 30 for receiving the audio visual program content. On the receiving end, the DPIS allows for insertion of the custom content that allows the hospital to create its own branded platform. As an example, two 30 second commercial avils and two identification spots can be customized with hospital promotional messages, public service announcements, or commercials to create a custom branded platform that suits the business purpose of the hospital.

To offer generic content of a unique brand, the digital files that contain the branding content and local advertising (if any) are stored in a local DPIS (which is not necessarily the physical location of the end user server system, but is described as such to define its purpose). In order to facilitate integration of programming content with commercials and other customized content, playout server 18 will send a cuing tone to the local DPIS 32 that initiates the local DPIS to insert the appropriate digital content at the proper time and with the proper duration.

In the embodiment as applied to a hospital setting, the hospital digital content can be general hospital messages, public service announcement, a self-help message, and a spiritual, comforting message. From a business perspective, the hospital custom branded platform can deliver and reinforce the hospital branding promotion efforts. Additional opportunities exist for the hospital from selling the commercial avils time to related companies such as medical service companies, pharmaceutical companies, insurance companies, etc.

The above description of the customized media platform is illustrative of the general concept. Additional embodiments are available related to additional degrees of platform customization, other methods of connectivity and other customized platforms created for a category of end users based on a product or service instead of a particular end user. The following descriptions of customized content are illustrative, and it is understood that the technology which has been used is intended to be in nature of words of description rather than of limitation.

Levels of customization include a basic generic platform and a dedicated custom branded platform. The basic generic platform is the lowest level of customization as it consists of the content in the 15 minute segment format described above. This is the lowest cost platform as the content is 13 minute, 50 second long episodes played out unmodified. The custom branding comes from the two platform identification spots and the two 30 second avils for either ad revenue generating commercials or public service announcements, or other messages relating to the end user's business or generic video with a custom audio track. This platform uses the same video content as the generic but with a modified audio track of voice and music. Generic video with custom audio represents a higher level of branding as the audio message is specific to the end user and the 13 minute 50 second episodes as well as the ID and two 30 second avils. This platform, as well as all other higher level of customization platforms, requires multiple end user distribution systems as illustrated. This platform is more costly to produce, but provides more powerful branding potential.

The dedicated custom branded platform is essentially a completely unique platform as both HRT video and audio components are customized for the specified end user. The time schedule format can be whatever the end user desires and is not bound by the 15 minute format of the generic platform. Content episodes could be one half hour or one hour or any other time interval. There may be more or fewer avils and the avils may be longer or shorter. The dedicated custom branded platform is more costly to produce than the generic or the generic video with custom audio; however, the return on investment is likely to be justified by its greater branding power and ad revenue generation potential.

The lowest level of customization would be the playout of the generic HRT content that any end user can customize into a branded platform by inserting local content in a standard time format as described in the embodiment above, in which a satellite delivers the signal over a wide geographic area through an uplink antenna and downlink antenna.

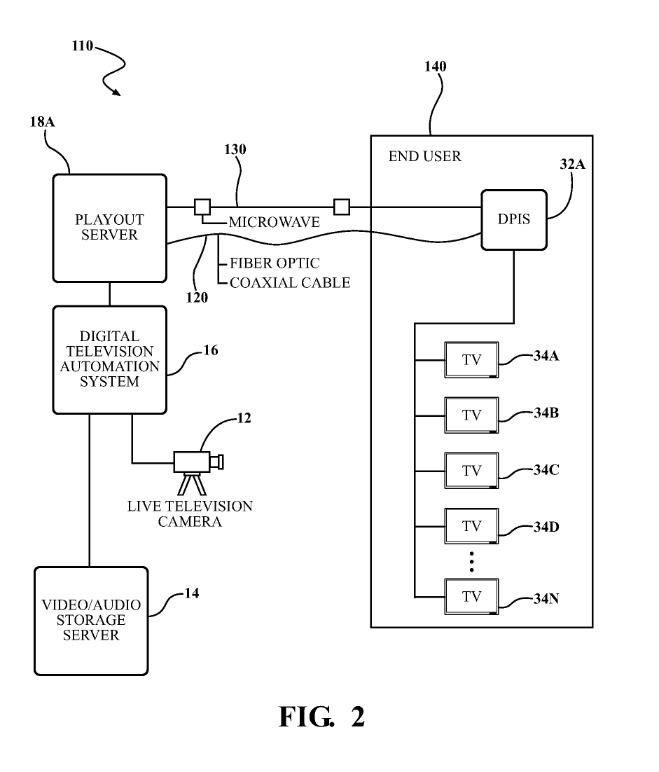

Referring to FIG. 2, an embodiment of the customized media platform 110 is illustrated. In this embodiment, the playout server 18a is in communication with the DPIS 32a via a fiber optic cable 120 or a microwave signal emitter 130. In this embodiment, an end user 140 could be a hospital or another institution or entity interested in receiving customized audiovisual content.

A higher level of audio video customization includes adding a different audio track to the video track, in a manner as explained above. A unique audio track of both voice and music could brand the platform more strongly than the basic generic platform. The next level of customization would involve the changing of the time format of the HRT content or changing the sequence or duration of insertible content. All of the levels of customization above the basic generic level make for unique demands on the method of connectivity. In some cases, the most economical connectivity would favor direct public or private platforms connected over a satellite method as described above. Satellite delivery is most economical when many widely located end users are receiving a basic generic HRT content. This is so because the cost of the bandwidth rental (about $15,000-$30,000 per month) can be allocated among hundreds of users, thereby making the individual user cost a few hundred dollars. However, any level of customization higher than the basic level requires unique connectivity between the originator and the end user. For this service, point-to-point connectivity as illustrated in FIG. 2 would be more economical at about $3,000-$5,000 per user versus $15,000-$30,000 per end user with a unique satellite based system.

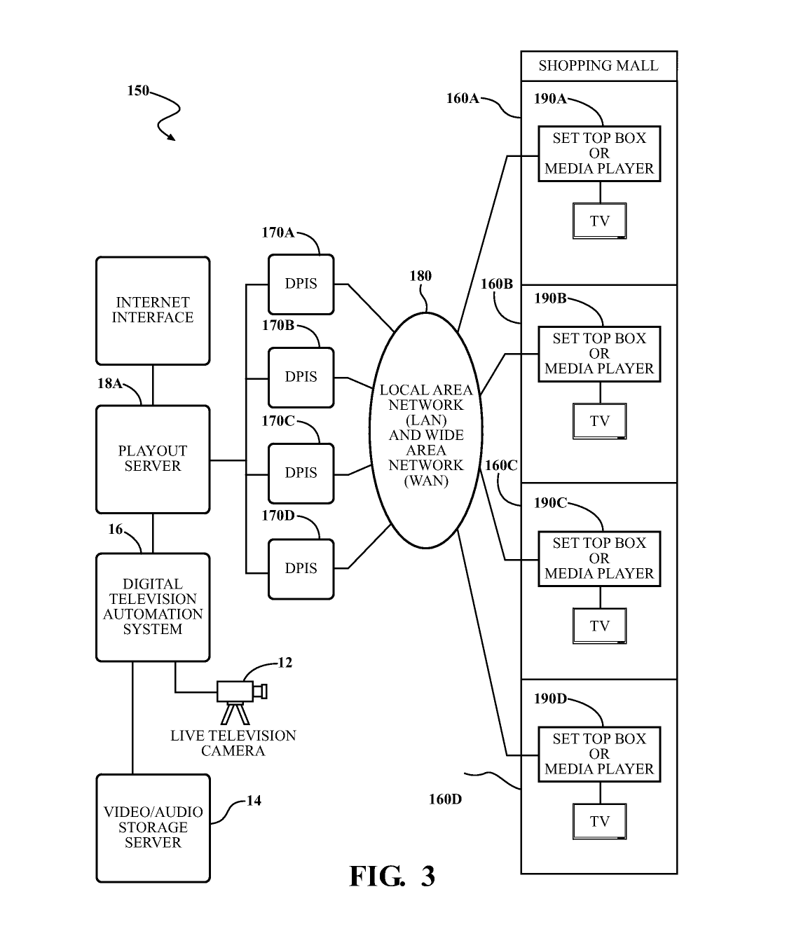

Now referring to FIG. 3 is a second alternative embodiment of the customized media platform 150. In this embodiment, multiple end users 160a, 160b, 160c, and 160d of higher-level custom branded platforms are served by multiple DPIS' 170a, 170b, 170c and 170d via a network connection 180. The network connection 180 can be a local area network, wide area network, or combination of LAN and WAN. In this embodiment, the digital signal received from the playout server 18a is converted back to audio and visual content by set top boxes 190a, 190b, 190c and 190d connected to a television or monitor.

In this embodiment, the customized media platform is created for end users that fall into categories rather than a specific end user. These end user categories could be beauty salons, country clubs, marinas, restaurants, retail automotive part suppliers, businesses, schools, government entities, religious entities, and a multitude of other numerous but widely geographically located organizations. As with the other embodiments, the bulk component to the platform is affordable HRT content. The custom content is inserted by the DPIS devices 170a, 170b, 170c, and 170d at the point of origin. The platform is delivered by network 180 to individual IP addresses for communication to internet-enabled television sets or monitors enabled through set top boxes 190a, 190b, 190c, and 190d. Taking a country club or golf equipment store as an example, the HRT content can play as described, in 15 minute blocks, containing two platform ID spots plus two 30 second advertisement avils. The avils can be for golfing related products or services. Additional long form content such as golfing instruction videos or golfing news stories can be inserted from time to time. This category based custom branded platform, depending on the category of interest, can have thousands or tens of thousands of subscribers. The revenue generation of this network distributive platform is from subscription fees, advertisement avil sales, and interactive e-commerce, such as but not limited to, enhanced binary information exchange (“EBIF”).

Although a hospital or hospital system would be an ideal user for the custom branded platform, other business entities such as corporations and private companies (larger or small) that have an eternal media facility (from thousands of users to individuals) can use a branded custom platform to promote their brand and generate revenue. Additionally, corporate platforms that have limited amounts of business-related content can use HRT content as filler content when there is no corporate content to be aired. Other television networks could also incorporate custom-branded HRT content under their own name and logo to provide filler content as scheduling requirements demand or as a full time service in a digital broadcast subchannel.

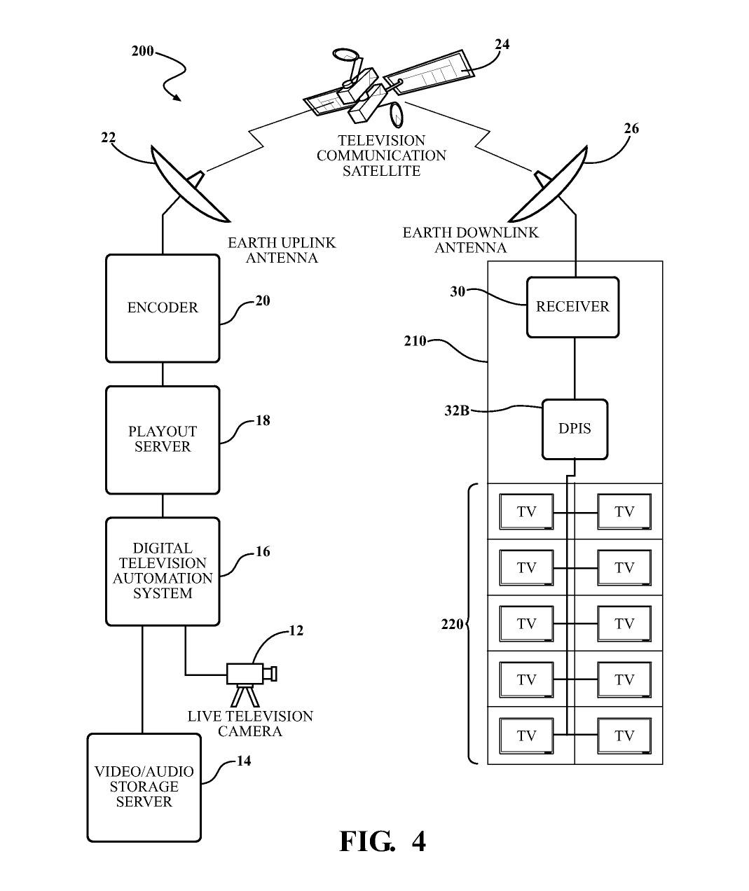

Referring to FIG. 4, a third alternative embodiment of a customized media platform 200 is illustrated. In this embodiment, the end user is a shopping mall in which are located a dozen or more stores representing extended end users. Each of the end user stores has a television or monitor coupled to the DPIS 32b. If the end users are all receiving the base generic custom platform then the DPIS 32b can be used to insert the necessary number of custom content simultaneously. For this service, the satellite system is an economical solution.

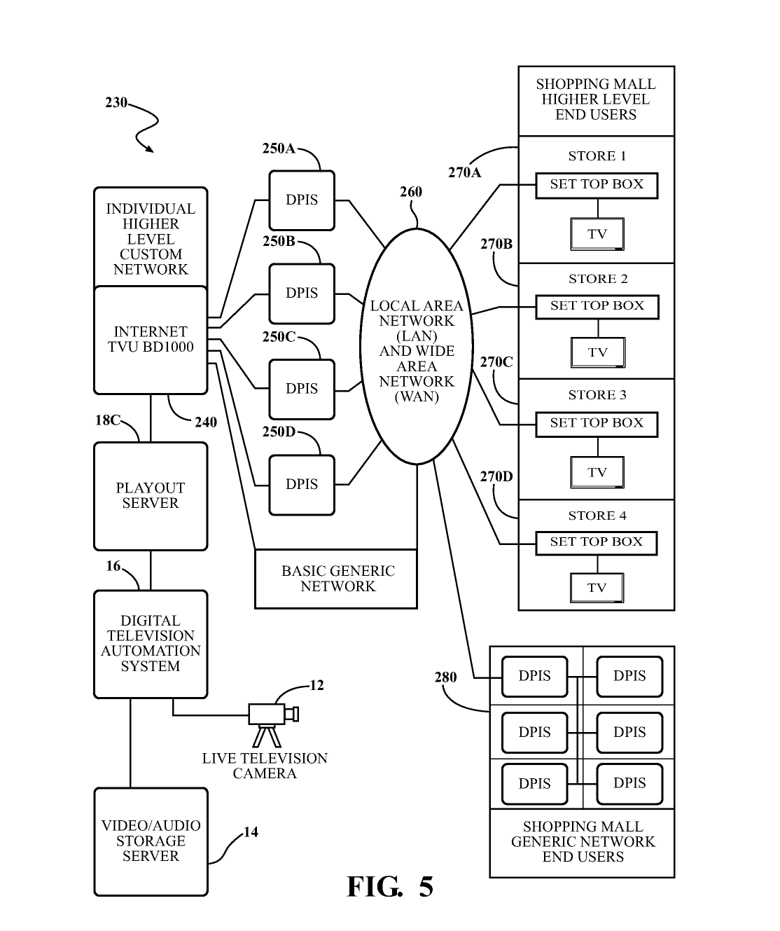

Referring now to FIG. 5 is a fourth embodiment of the customized media platform 230. In this embodiment, playout server 18c is coupled to internet cloud 240, which in turn is in communication with a plurality of DPIS' 250a, 250b, 250c and 250d, which in turn is in network communication through network 260 with a plurality of end users 270a, 270b, 270c, 270d, and including connection to a bank of additional DPIS' 280. In this embodiment, expanding on the previous example, one or more stores may be part of a larger chain, each of whom have their own higher level custom platform, in this case each unique platform can be delivered by a network that allows virtually unlimited users.

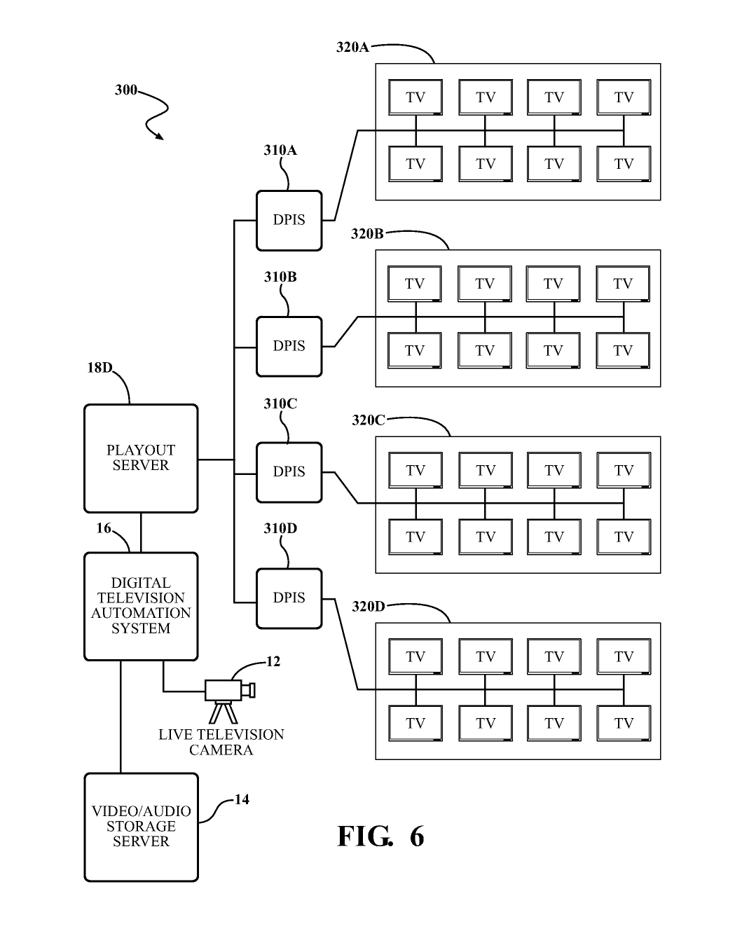

Referring now to FIG. 6 is a fifth embodiment of a customized media platform 300. In this embodiment, playout server 18d is in communication with a plurality of DPIS′ 310a, 310b, 310c, and 310d, which in turn are in communication with a plurality of television or monitor banks 320a, 320b, 320c, and 320d.

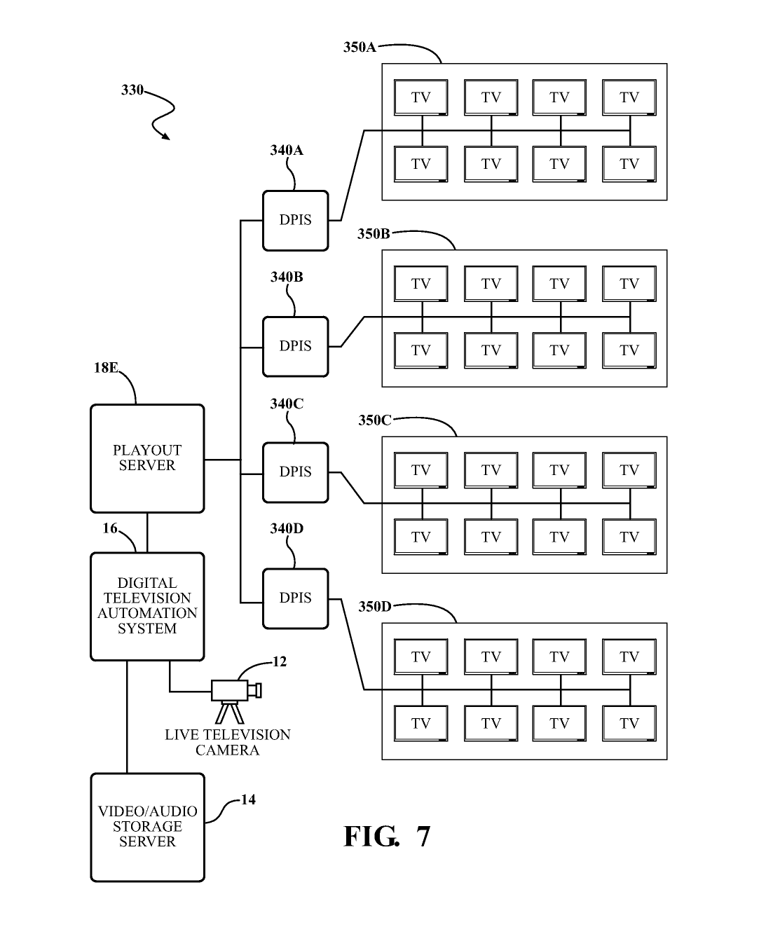

Now referring to FIG. 7 is a sixth embodiment of the customized media platform 330. In this embodiment, playout server 18e is separately coupled to each of a plurality of DPIS′ 340a, 340b, 340c, and 340d, which are in communication with a plurality of television or monitor banks 350a, 350b, 350c, and 350d.

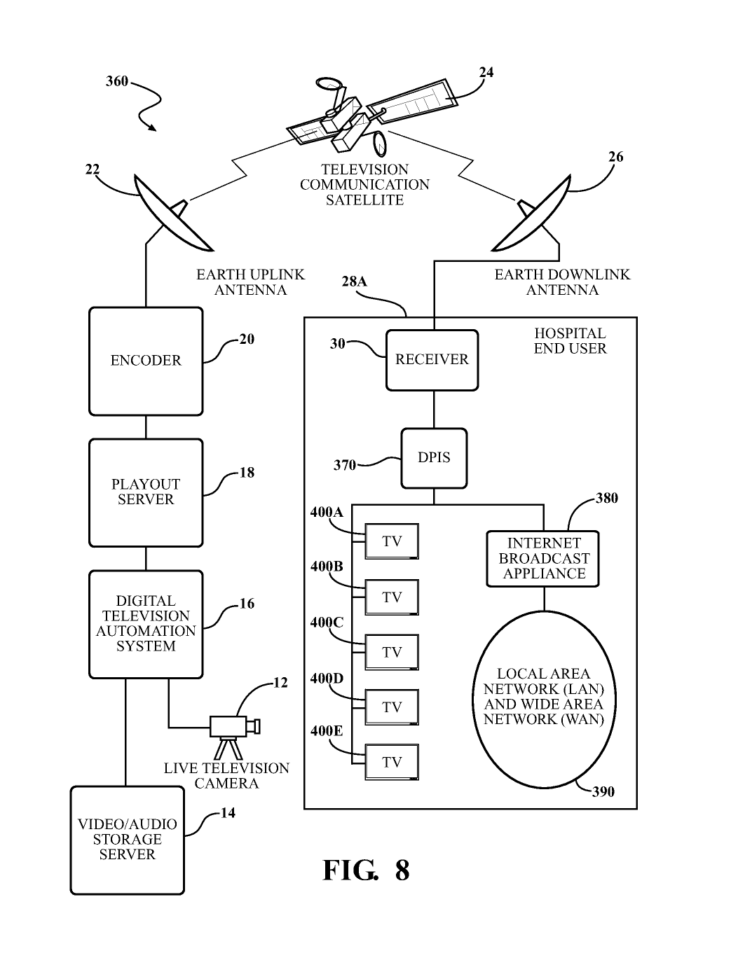

Referring to FIG. 8 is a seventh embodiment of a customized media platform 360. In this embodiment, hospital end user 28a has a DPIS 370 connected to an internet broadcast appliance 380 which in turn is in communication with a network 390, including a LAN and WAN. DPIS 370 is also coupled to a plurality of televisions or monitors 400a, 400b, 400c, 400d, and 400e. In this embodiment, the customized media platform includes signal delivery and distribution initiated by a LAN or WAN, with distribution at the end user hospital 28a. The signal from the originator is delivered to the end user by either satellite or direct point-to-point method as shown in previous embodiments. Using as an example a university as an end user, the university may want a custom branded platform available not only on campus, but to alumni scattered all over the globe. An efficient way to do this is to have an internet broadcast appliance connected to the LAN or WAN after the DPIS.

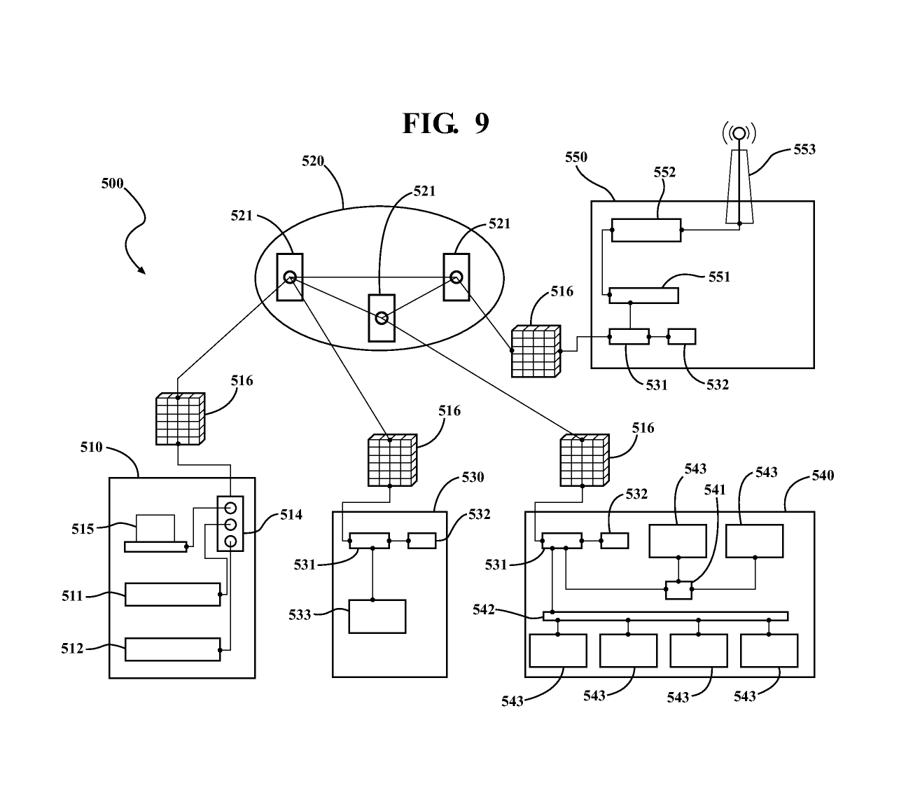

Now referring to FIG. 9 is an eighth embodiment of a customized media platform 500. In this embodiment, a control node 510 includes digital media storage and software based on television production and playout functions. Other technology such as analog TV systems can also be employed for the PCBN, but because it is an older technology being rapidly replaced by digital technology, it will not be described in detail. The control node has a production archive main server 511 and a production archive back-up server 512. The servers are coupled to a router 514, which is also coupled to the master control workstation 515. The master control workstation is used to create the playlist for the PCBN. The router is connected to the internet 520 through the control nodes firewall 516. At the edges of the internet cloud are content delivery network servers (“CDN”) 521. These CDNs are connected through premises firewalls 516 to large and small facilities. Within the small facility 530 is an HD media player (“HDMP”) 531 and its associated media storage device 532, which is typically an external hard drive. The storage device is preloaded with an initial play list consisting of HRT and other suitable content along with the end user's advertisement and branding content. The HDMP output signal is provided to a television monitor 533. In the case of a large facility 540, one HDMP can provide an output signal to multiple monitors 543 through the facilities signal splitters 541 and internal distribution network 542. The HDMP can be supplied in a wireless design, thereby making installation of the internet connection less intrusive.

PCBN also can be used to provide content to terrestrial broadcasters 550 and to cable television distribution systems. Using the terrestrial broadcast as an example, the signal output of the HDMP is fed to a signal converter 551 and then to a broadcast equipment 552 and then to an antenna 553. In the case of cable distribution, the HDMP signal is played out through the cable medium.

If the network is geographically widely spaced, then other HDMPs 531 are employed in each location. In operational practice, whether a single or multiple HDMP is being employed, the PTN operates as follows: HDMPs are connected to a control node through premises firewalls 516 to the internet cloud 520. The internet connection allows the control node's master control workstation 515 to update new content and/or create new play lists as often as required. The HDMP's can be time synchronized so that all viewers see the same program at the same time. The HDMPs can also be controlled so that different viewers in different time zones or activity schedules see programming appropriate to the time zone they are located in or to the activity that is appropriate to their facility.

Each HDMP can have customized content for that particular HDMP location. As an example, say a health care system consists of 8 hospitals, 25 clinics and 400 individual doctor offices. All these various network locations can be supplied with HDMPs that have content that is common to all, and each can have content that is particular to its location. HDMP's also can be programmed to zone the television monitor screens into different sections to display test messages and logos in crawling information ribbons, thereby increasing the amount of unique information and branding to each location of the network. In this example, the hospital PTNs and HDMP and the hard drive would contain some content common to the entire network, but could also have branding and commercials unique to the hospital while a doctor's office on the same network would also have common content, but may also have the doctor's office hours or some content personalized for the particular doctor. This aspect of the HDMP capabilities is also known as digital signage (“DS”). Digital signage is widely used in various businesses and institutions to display statistic advertising graphics, way finding, and audiovisual content. A desired objective of DS is to entice the viewer to watch the motion picture advertisement or branding messages. Again taking hospital and other medical waiting rooms as an example for digital signage, one can readily appreciate the continuous streams of DS commercial ads would be repetitive and annoying. For the same reason that entertainment is the basis for television networks such as CBS, NBC, ABC, FOX and others, the HDMP PCBTN uses the HRT entertainment component to entice viewers to watch and so when the ad or branding message plays after the entertainment content ends, the viewer experiences a television format that is familiar, acceptable and effective.

The HDMP private custom branded television network offers an affordable, effective and flexible television-based communication network that can be uniquely tailored to the needs and desires of the end user, no matter how large or small the end user is, no matter how large or small the PCBTN is.

The present invention may also be practiced with computer networks, smartphones, and other types of networks.

While particular embodiments of the invention have been shown and described, numerous variations and alternative embodiments will occur to those skilled in the art. Accordingly, it is intended that the invention be limited only in terms of the appended claims.

What is claimed is:

1. A method for customizing audiovisual content at an end user location, the method comprising:
providing an audiovisual broadcasting system for broadcasting live and recorded audiovisual content, wherein the audiovisual content is digitized, and wherein the broadcasting system comprises a playout server for receiving, storing and transmitting audiovisual content wherein the broadcasting system further comprises a transmitter for transmitting audiovisual content;
transmitting audiovisual content to a digital program insertion server at an end user location;
inserting into the audio visual content additional content wherein the additional content includes at least one of advertising and customized content, wherein the customized content is specific to the end user; and
transmitting by the playout server a queuing signal for signaling the insertion point in the audiovisual content for the additional content.

2. The method for customizing audiovisual content at an end user location of claim 1, wherein a digital program insertion server, after customizing the audiovisual content, transmits the audiovisual content to one or more display monitors.

3. The method for customizing audiovisual content at an end user location of claim 1 wherein the playout server is coupled to an encoder for encoding the digitized audiovisual content for transmission through satellite communications to a receiver coupled to the digital program insertion server.

4. The method for customizing audiovisual content at an end user location of claim 1 wherein the playout server is in communication with the digital program insertion server through a direct connection including at least one of a fiberoptic cable, coaxial cable, and a microwave signal.

5. The method for customizing audiovisual content at an end user location of claim 1 wherein the playout server is in communication with a plurality of digital program insertion servers wherein the plurality of digital program insertion servers are in communication with a network including at least one of a local area network and a wide area network, wherein the digital program insertion servers communicate with a device connected to a monitor for transmitting customized audiovisual content to the monitor.

6. The method for customizing audiovisual content at an end user location of claim 1, wherein the audiovisual content comprises hybrid radio/television content.

7. The method for customizing audiovisual content at an end user location of claim 6, wherein the hybrid radio/television content is at least one of a nature scene, water scene, and cityscape without dialogue.

8. A system for customizing audiovisual content at an end user location, the system comprising;
a digital television automation system for receiving live or recorded audio visual content.
a playout server coupled to the digital television automation system for distributing through a network audiovisual content;
a communications network for receiving the audiovisual content from a playout server and communicating the audiovisual content to a receiver;
a receiver for receiving the audiovisual content;
a digital program insertion server coupled to the receiver for accepting the audiovisual content and inserting advertising or user specific content into the audiovisual content, wherein the audiovisual content includes a queuing signal for signaling an insertion point for insertion of the advertising and end user specific content; and
wherein the digital program insertion server is in network communication with a plurality of monitors for displaying the audiovisual content, advertising and end user specific content.

9. The system for customizing audiovisual content at an end user location of claim 8, further comprising a program executing on the digital program insertion server wherein the program monitors for said queuing signal and inputs the user content into the audiovisual content whereby the audiovisual content is unique and customized to an end user.

10. The system for customizing audiovisual content at an end user location of claim 8, further comprising a network including at least one of a local area network and a wide area network disposed between the digital program insertion server and the monitor for communicating the customized audiovisual content to the monitor.

11. The system for customizing audiovisual content at an end user location of claim 8, wherein the audiovisual content comprises hybrid radio/television content wherein the hybrid radio/television content includes at least one of a nature scene, water scene, and cityscape scene with no human dialogue.
